(19) United States
(12) Patent Application Publication
(10) Pub. No.: US 2005/0050260 A1
(43) Pub. Date: Mar. 3, 2005

(54) Reverse search system and method

(76) Inventors: Alon Schacham, Ra'anana (IL); Avi Matza, Yam (IL); Yves Villaret, Hadera (IL)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/491,164

(22) PCT Filed: Sep. 30, 2001
(86) PCT No.: PCT/IL01/00915

(51) Int. Cl. G06F 12/00

(52) U.S. Cl. 711/100

(57) ABSTRACT

A system for checking the presence of one or several words from a given list in an input put string of subwords. The list of words is stored in a memory array comprising one comparator for each memory cell storing one subword. The string is divided in sub-strings. Each sub-string is loaded several times unto a compare register, each time being roll-shifted by one sub-word. At each memory cell, simultaneous comparisons are made with the input sub-string. A logic circuit for each memory cell detects consecutive matching of sub words of the string with the sub-words of a word of the list. Whenever a match occurs for a full word of the list, a signal is set for for this word. A List Match signal is set, and a priority encoder may be used to output the address (position) of one of the matching words.

### BACKGROUND OF THE INVENTION

The present invention concerns a system and method to be applied in a communications system for detecting the presence of one or more words out of a predetermined list in a string of data.

Such checking procedure may be employed to detect and block packets of data containing Virus signatures or to detect and block addresses of specific Internet sites.

When searching in data the presence of words out of a pre-defined list, the eventual position of the word in the data is not known, and usually there is no marking or sign that indicates the beginning of the searched words in the data. For example, if the data to be searched is a packet of byte data, the words to be searched may start at any byte position in the data. The number of searches to be done is thus very high, because each starting position is to be checked, and the total searching time may be very long.

Such a checking procedure, when used to check data, will reduce the operating speed of the total system. In existing systems, mainly software is used to perform the comparison and the processing unit will make one comparison of one word from the list with one portion of the data. Since there may be many words in the list, the processor will use a procedure of dividing the data in sections, each section having the size of one word of the list. Then the processor will make a comparison of each section with the same word. This entire procedure will then be repeated as many times as there are words in the list. The total time required for the data checking operation may then be very long, and will significantly reduce the operation speed of the communication or computer system.

It is therefore desirable to provide a checking system that is capable of detecting the presence in a batch of data of one or more words out of a pre-stored list of such words at high speed.

### SUMMARY OF THE INVENTION

The present invention provides a system and method for checking the presence of one or several words from a given list in a string of sub-words. The list of words is stored in a memory array comprising one comparator for each memory cell storing one sub-word. The string of data to be checked is divided in a series of sub-strings. Each Sub-string is loaded several times unto a compare register, each time being roll-shifted by one sub-word. At each memory cell, simultaneous comparisons are done with the input sub-string. A logic circuit is associated with each memory cell to detect consecutive matching of sub-words of the input string with the sub-words of a word of the list. Whenever a match occurs for a full word of the list, a signal is set for this word. Finally a global Match signal is set, and a priority encoder may be used to output the address (position) of one of the matching words.

### BRIEF DESCRIPTION OF THE DRAWINGS

FIG. 1 is a block diagram showing the general arrangement of a preferred embodiment of the inventive reverse search system.

FIG. 2 shows the order defined for the array of memory cells used in the reverse search system to store a list of words.

FIG. 3 shows two adjacent memory cells Mᵢ and Mᵢ₊₁ at positions i and i+1, the circuit associated to these memory cells and the input and output signals of a circuit (Lᵢ) associated with each memory cell Mᵢ of the Memory Array.

FIG. 4 shows a logic circuit implementing the function of the Lᵢ circuit.

FIG. 5 shows an OR circuit that generates a List Match signal.

FIG. 6 shows a Priority Encoder that may be applied in case of several simultaneous match results

### DETAILED DESCRIPTION OF THE PREFERRED EMBODIMENT

The present invention provides a method and system for performing a checking operation whereby the presence of one or more words out of a predetermined list of words may be detected in a string of data. In accordance with the inventive system and method, the list may contain words of various length.

In a communication system, it may be desired to check whether data flowing through the communication apparatus contains one or several words out of a predetermined list of words. For example, the list of words may be a list of Virus signatures, and the novel system will be employed to detect and block packets of data containing such Virus Signature. In a second example, the list of words may be a list of Internet addresses of sites to which access is to be blocked.

In accordance with another application in a computer system, it may be desired to store data in different areas, the selection of the areas being dependent on the kind of data to be stored. For this purpose, a list of words is stored, that characterize the data selection, and if one word of the list is present in the data, then data is stored in a selected area. Several different lists of such words can be defined, and a classification of the data can be done, according to the words found in it. Such storage enables searching for a text containing one of the words related to a given subject.

The above described search procedures tend to considerably lower the overall system operation speed.

In the present invention a checking system is proposed wherein a large number of comparisons are done in a single comparison cycle, resulting in a considerably increased speed of operation. The size of Data that can be checked per time unit is very large, and the inventive checking procedure can be used in communication or computer systems with a minimum or null influence on the total system speed of operation.

A system built according to the invention can be used in many computer and communication systems, for example for virus detection, firewall, intelligent routers, protection against intruders, data-base management, etc . . .

Such a search procedure wherein a string of data is searched for the presence of one word from a list of words as opposed to a procedure where one predefined word is searched among a list of words shall be referred to herein as a “Reverse Search” system.

The invention will be described hereinbelow in detail in respect of a preferred embodiment. It will be understood however that many variations and modifications of the invention may be made without departing from the invention in its broader aspects and therefore the appended claims are to encompass within their scope all such changes and modifications as fall within the true spirit and scope of this invention.

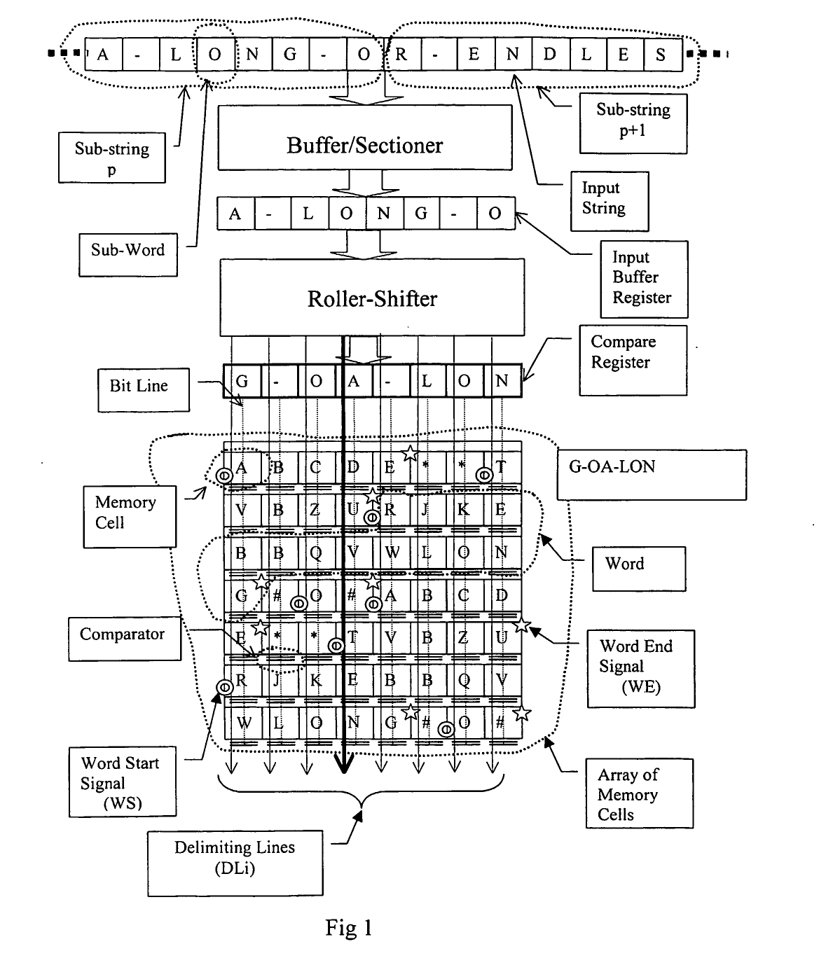

In FIG. 1 a general block diagram is shown. The data to be searched and checked is shown in the form of a String of characters (Input String), and is input to the reverse search system for the purpose of detecting the presence of one or several words from a pre-stored list, the List of Words. The data can be of any kind, and the characters shown in FIG. 1 represent any kind of data, having an arbitrary number of bits, that data being an elementary portion of data, further called here “Sub-Word”.

An Input Buffer Register is used to store a number n of Sub-Words of the Input String, each Sub-Word being stored in one memory cell. A Buffer/Sectioner is used to divide the Input String in sub-strings of reduced size, each sub-string comprising a number of sub-words smaller or equal to the number of sub-words that can be stored in the Input Buffer register. This Buffer/Sectioner then sequentially writes the data of all the Sub-strings of the Input String into the Input Buffer Register for the purpose of comparing that data with the data stored in the Memory Array. All Sub-strings of the input string are successively input into the Input Buffer register. Each sub-string is then checked and compared to the “List of Words” by a procedure explained below. The whole Input String is then checked when all sections have been “passed and checked” through the Input Buffer register. The Buffer/Sectioner function is not shown here. It can be implemented by means of a processor and/or a logic circuit, using common software and hardware techniques. In particular, this Buffer Sectioner may be operating on flowing data, i.e. receiving the input string progressively from a communication line. In that case, the input string may be of infinite length. Each time n sub-words are received, the n sub-word sub-string is loaded to the Input Buffer Register and checked. In FIG. 1 two sub-strings p and p+1 of the input string are shown, and the Input Buffer Register is shown storing the data of the p sub-string.

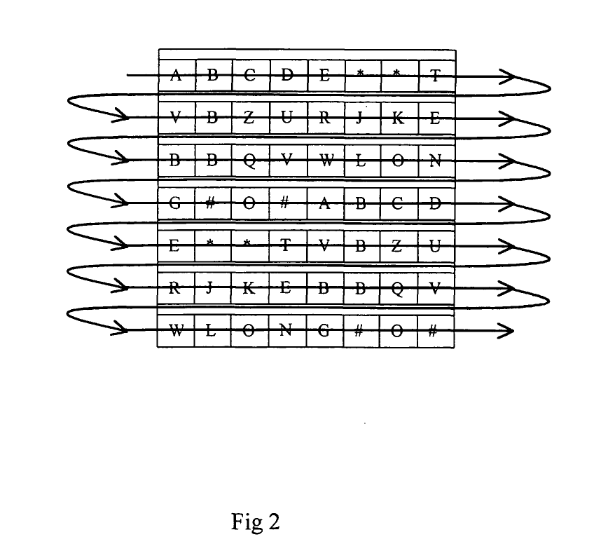

Also shown in FIG. 1 is an Array of Memory Cells used to store a list of words, each Memory Cell being able to store one Sub-Word. Each Word consists of a String of Sub-Words stored at consecutive memory cells, according to a predefined order of the memory array. Such a predefined memory order is shown in FIG. 2.

Also shown in FIG. 1 are a Word Start signal and a Word End signal. These signals can be set for each Memory Cell and are used to mark the first and last Sub-Words of a word stored in the Memory Array. These signals can be set by various means, upon loading the memory array with the list of Words. In FIG. 1 Word Start signals are shown as ⋆ and Word End signals as ⊚.

The system shown in FIG. 1 also includes a Compare Register comprising a number n of memory cells, thus being able to store n Sub-Words.

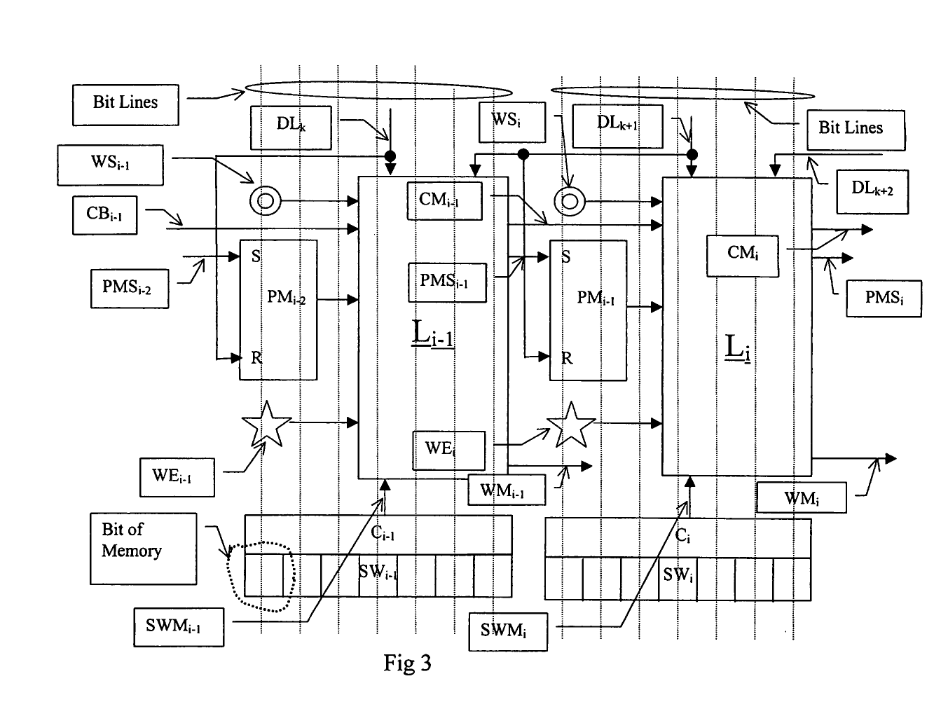

As shown in FIG. 1 and with more detail in FIG. 3, a comparator Cᵢ is associated with each Memory Cell of the Memory Array. The data of one Sub-Word stored in one Cell of the Compare Register is input to this comparator by means of bit lines shown in FIGS. 1 and 3. In FIG. 3, one bit line is shown for every bit of the memory cell. In FIG. 1 only one line is shown for a whole sub-word, and this for the purpose of clarity.

However each sub-word comprises a number of bits and, typically, one or two bit lines are needed per bit of the sub-word. It should be understood that per each sub-word, there are at least as many bit lines as there are bits in the sub-word.

For each memory cell, the comparator is designed to compare the Sub-Word stored in the Memory Cell with the Sub-Word of one Cell of the Compare register. This kind of comparator is of common use in Content Addressable Memories. The connection of the bit lines is cyclically arranged, so that the comparators of two adjacent memory cells k and k+1 receive as input the data of either two adjacent cells or of the last and first cell respectively, of the compare register. In the present specification a memory cell will be defined as “aligned” with a given cell of the Compare Register when the comparator of that cell of the memory array receives as input the data stored in the said cell of the compare register.

Referring again to FIG. 1, a roller/shifter circuit is shown. The function of that circuit is to move the Sub-string from the Input Buffer Register into the Compare Register a required number of times, shifting and rolling the data one or more times after each input of the data into the Compare Register. The result is that each Sub-String will be loaded and compared to the words of the Memory Array with all shift-rolled possible configurations, including the possible eventual match. Shifting and Rolling means here that a sub-word stored in cell k of the compare register is moved to cell k+1 if k<n, and the sub-word in the last cell n is moved to the first cell 1. It will be understood that while in the preferred embodiment the shift/roll operation is clock wise, an anti clock wise shift roll operation is also envisaged in the scope of the inventive method and system.

The required number of shift-roll operations in the preferred embodiment of the inventive method is equal to the number n of sub-words in the compare register. It will be understood however that the number of shift-roll operations may be smaller than n, depending on application requirements. It is envisaged within the framework of the inventive method that the inventive system may be operated in accordance with rules that define a restricted number of matching cases.

Thus for example, it may be desired to operate the reverse search system at high speed. For that purpose a method of reverse search may be applied wherein each word of the list is loaded twice in the Memory array and the said two appearances of the same word are positioned such that the first sub-word of the first appearance of the said word is aligned with a subword of the compare register that is removed at a distance of n/2 sub-words from the subword that is aligned with the first subword of the seond appearance of the said word. Due to this method of double loading the words of the list into the memory array, only n/2 roll/shifted positions will be needed when checking for the presence of one word of the list, since the eventual match may occur either on the first or second appearance of the word in the memory. It will be understood that where even faster operation is required the list of words may be loaded in the Memory array a number of times that is more than two.

Also in FIG. 1 are shown a set of n “Delimiting Lines”, DL₁ to DLₙ. One delimiting line is associated with each memory cell of the compare register. Each delimiting line is routed to all Memory Cells that are aligned with the Memory Cell of the compare register associated to that Delimiting line. The Logic State of a delimiting line will be set to logic 1 in the case where the cell of the compare register that is associated with the said delimiting line is storing the first sub-word of the sub-string presently being checked. As a result, the signal on the delimiting line will mark the new position of the first sub-word of the sub-string after each roll-shift operation. In the example of FIG. 1, the sub-string “A-LONG-O” has been loaded in the Input Buffer Register, and after rolling-shifting 3 times it has been loaded in the compare register as “G-OA-LON”. The third delimiting line, immediately before the “A” character at the beginning of the sub-string, will then be set to logic 1 thus marking the first subword of the sub-string. This signal on the delimiting line, will then be input to all the logic circuits associated with memory cells “aligned with” the memory cell of the compare register that contains the first sub-word of the sub-string. The third delimiting line set to logic level 1 is shown in bold in FIG. 1.

In this preferred embodiment one delimiting line is used for each cell of the compare register. In that case this delimiting line being set to logical state 1 marks the first sub-word of the sub-string; the last sub-word of the sub-string is then marked by the delimiting line of the next sub-word being set. In another preferred embodiment within the scope of this invention, two different lines may be used per each sub-word, one being used to mark the first sub-word, and the other one to mark the last sub-word. In such case, the sub-string stored in the compare register may be of smaller size than the compare register itself. The preferred embodiment is described here with one delimiting line per compare register cell for the purpose of clarity only. In a system where both first and last sub-words of the sub-string stored in the compare register are marked by a signal these two marks are conveyed to all cells of the memory array that are aligned with the cells of the compare register in which the data of these first and last sub-words are stored. Where two delimiting lines are used per each subword of the compare register, the first subword of the substring is marked by setting one of these delimiting lines and the last subword of the substring is marked by setting the other delimiting line. The preferred embodiment is a simplified case where the first Sub-Word of the compare register is marked by setting one associated Delimiting line, whereby the preceding sub-word will be automatically marked as the last sub-word.

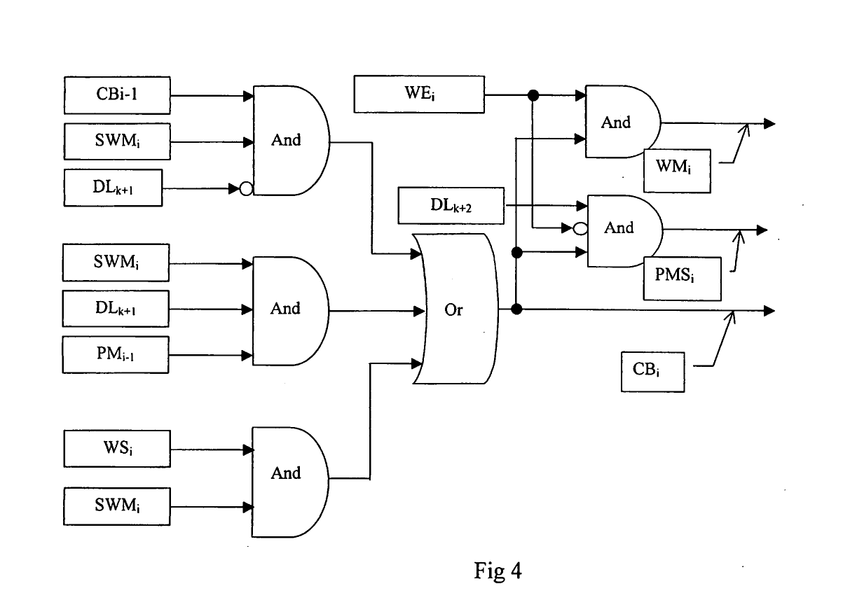

In FIG. 3 two adjacent cells i−1 and i of the memory array and the associated circuits are shown. The blocks Lᵢ₋₁ and Lᵢ represent logic circuits to be described later in respect of FIG. 4. The Lᵢ circuit has 3 output signals, CMᵢ, PMSᵢ, WMᵢ, and 7 inputs, SWMᵢ, WSᵢ, WEᵢ, CMᵢ₋₁, PMᵢ₋₁, and the signals of the delimiting lines DLₖ and DLₖ₊₁.
SWMᵢ, Sub-Word Match, is the output signal from the comparator of the Memory Cell. In case of a match the signal is set.
CMᵢ, Combined Match, is an intermediate signal generated to check matches of several consecutive Memory Cells.
WSᵢ and WEᵢ, are the Word Start and Word End signals.
The PMᵢ₋₂ and PMᵢ₋₁ blocks represent a signal, “partial match”, which is set by the PMSᵢ₋₁ signal, output from the preceding Lᵢ₋₁ and reset by the delimiting line signal. The PMᵢ₋₁ signal is used to store information that an ending part of the Sub-String was found matching part of a Word in the memory array. There is the possibility that the following characters of the input string that will be loaded in the following Sub-String will match the following part of the Word.
WMᵢ, Word Match, is a signal that indicates that the whole word has been found matching.

We shall first describe the general function of the Reverse Search system, then show the details of the logic circuit for the preferred embodiment.

As explained before, the Input string is divided into sub-strings by the buffer/sectioner and all sub-strings are loaded one by one to the Input Buffer Register. Each sub-string, when loaded in the input Buffer register, is shifted/rolled by one sub-word and loaded into the Compare Register n times. Each time the sub-string is loaded in the compare register with a given shift/roll, all comparators of the memory array execute simultaneously a comparison between the sub-words stored in the memory array and the sub-word stored in the aligned cell of the Compare Register. If a match is found, then a Sub-Word-Match signal SWMᵢ is issued at each matching memory cell of the array. These Sub-Word-Match signals are then logically combined, by means of the L circuits, with a) the match signal of the preceding cell, b) the Start and End of Word signals, c) the delimiting line signals and finally d) the “Partial Match signal” of the preceding cell, in order to output a Word Match signal if any series of sub-words of the input string matches the series of sub-words of any word of the list.

The principle of the function of the logical combination is as follows:

A Word Match signal is issued at the ending sub-word of a word of the list if all preceding sub-words starting from the starting sub-word of the word have matching signals. This is checked by the generation of a Combined Match intermediate signal at each Memory Cell. This signal is set when the stored sub-word of the memory cell is found matching, and the preceding Combined Match signal is also set. In the case where the word is present in the input string, but it is split between several sub-strings, then Partial Match signals are set each time a series of sub-words is found matching up to the end of the sub-string, the last sub word of that substring being marked by the delimiting line. When the next sub-string is loaded and shifted, whenever the position of the first word of this sub string corresponds to the position next to that where a partial match was found, the partial match is used as a condition for checking the next sub string. In the event of a partial match in the first sub string, the comparison process will be continued into the second substring whereas in the event that no match was found in the first substring, the comparison process for this specific word will be discontinued.

Where the comparison process reaches the end of the word with consecutive match results a Word Match Signal is issued.

The Partial Match signal, when having been set, should be reset after being used for the match checking of the next sub-string. This is done in the following way: For each cell of the memory array, each time the correspondent delimiting line is set, indicating that the Aligned cell of the compare registers contains the first sub-word of the sub-string, then the Partial Match signal, if set, is first input to the L circuit, then reset to logical zero.

In FIG. 4 is shown the logical combination that performs the above described function of the logic circuit Li. Such a logic circuit is associated with each of the cells within the array of memory cells that stores the list of words.

Each Li circuit outputs an intermediate combined signal, CBᵢ, which is input to the next Lᵢ₊₁, circuit. This combined signal is output if one of the three following conditions is verified:

a)_ The signal CBᵢ₋₁ of the preceding circuit Lᵢ₋₁ is also set and the Sub-Word i is found matching (i.e. the comparator Cᵢ outputs a SWMi signal), and the delimiting line is not set. This case indicates that the sub-string has been found matching for all preceding sub-words, starting from the first sub-word of the word.

Or b)_ The delimiting line is set, and the Partial Match is set, and the Sub-Word is found matching (SWMi is set). This case occurs when the Partial Match has been set by a preceding operation on a preceding sub-string.

Or c)_ If the sub-word is the first one of the Word (The Start Word mark SWᵢ is set), then CBi is set if the Sub-Word is found matching (SWMᵢ is set).

The Partial Match PMᵢ is set if the CBi is set, meaning that all preceding Sub-Words of the Word have been found matching, that the sub-word i is aligned with the ending sub-word of the sub-string and that the end of the word has not been reached. For this purpose, an AND function is provided that combines the CBᵢ signal, the DL signal routed to the next Memory Cell and the inverse signal of WEᵢ. The output of this AND function is then used to set the Partial Match signal.

A “Word Match” (WMi) is output if the following conditions are fulfilled: CBᵢ is set, meaning that all preceding Sub-Words of the Word have been found matching, and the sub-word is marked as the last “sub-word” by the word end signal (WEᵢ is set).

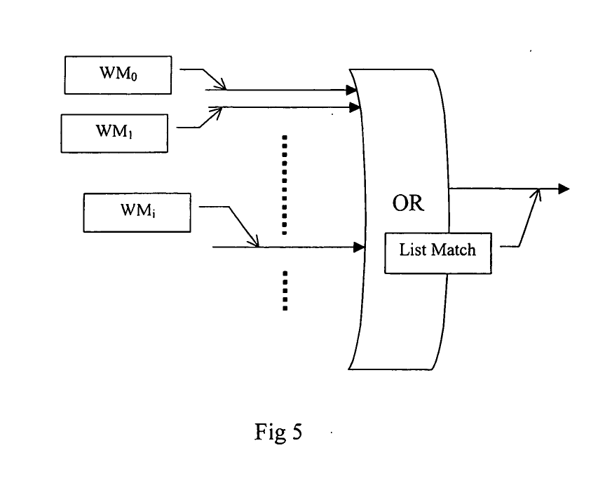

Finally, as shown in FIG. 5, a List Match signal is set if at least one Word Match signal is set.

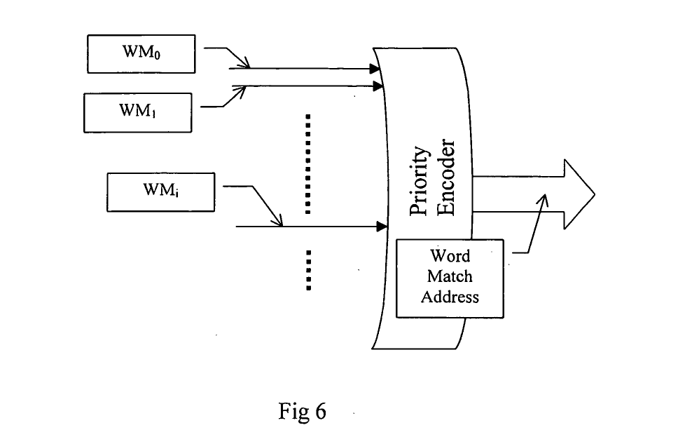

Furthermore, as shown in FIG. 6, all Word Match signals may be routed to a priority encoder, and the position (address) of one of the matching words may be output using the known technique of priority encoders.

The reverse searching system and method of the invention have the advantage that a plurality of consecutive search operations, checking a string of subwords for the presence at any position of one or more words of a list of words stored in a memory array may be performed continuously whereby a considerable saving in operation time is achieved.

1. A reverse search system for checking a string of subwords for the presence of one or more words out of a given list of words the said system comprising:
(a) a memory array for storing the said list of words, the said memory array comprising a plurality of memory cells arranged according to a predefined order, each memory cell storing one sub word and each memory cell being associated with a comparator means and a logic circuit;
(b) a buffer/sectioner means for dividing the said string of subwords into substrings having a number of subwords that is equal or smaller than a predefined number;
(c) an input buffer register circuit for storing the said substrings that is designed to contain a number of words that is equal or smaller than the said predefined number;
(d) a compare register circuit for storing the said substrings in different positions during the comparing operation;
(e) a roller/shifter circuit that feeds each of the substrings into the said compare register circuit several times wherein the said substring is shifted and rolled each time that it is fed into the said compare register circuit such that it may be checked in all required sub word positions;
(f) a set of bit lines for conveying data stored in the compare register to the said memory cells wherein the connections of the said bit lines are cyclically arranged such that the comparators of two adjacent memory cells receive as input either the data of two adjacent cells of the compare register or of the last and first cells of the compare register respectively;
(g) a set of delimiting lines for marking the new position of a sub word of the sub string after each roll shift operation by conveying a logic signal to the said memory cells wherein the connections of the said delimiting lines are cyclically arranged such that the logic circuit associated with two adjacent memory cells receives as input either the logic signals from two adjacent cells of the compare register or the logic signals of the last and first cells of the compare register respectively; whereby a plurality of consecutive search operations, checking the said string of subwords for the presence at any position of one or more words of the said list of words stored in the said memory array may be performed continuously.

2. A reverse search system for checking a string of subwords for the presence of one or more words out of a given list of words stored in a memory array as claimed in claim 1 hereinabove wherein each of the cells of the compare register is associated with one delimiting line and a delimiting line is set to logic 1 in the case where the cell of the compare register that is associated with that delimiting line is storing the first subword of a stored word presently being checked, whereby the said logic signal indicates to the said memory the location of the first subword of the said string of subwords as well as the location of the last subword of the preceding string of subwords.

3. A reverse search system for checking a string of subwords for the presence of one or more words out of a given list of words stored in a memory array as claimed in claim 1 hereinabove wherein each of the cells of the compare register is associated with a pair of first and second delimiting lines and the first delimiting line is set to logic 1 in the case where the cell of the compare register that is associated with the said first delimiting line is storing the first subword of a string of words presently being checked, thus producing a logic signal that indicates to the said memory the location of the first subword of the said string while the second delimiting line is set to logic 1 in the case where the cell of the compare register that is associated with the said second delimiting line is storing the last subword of the string that is presently being checked, thus producing a logic signal that indicates to the said memory the location of the last subword of the said string.

4. A reverse search system for checking a string of subwords for the presence of one or more words out of a given list of words stored in a memory array according to claim 1 wherein the said roller shifter circuit is inactive, only one subword is fed into the said input register and only one subword is fed into the said compare register and the said checking operation may be completed by implementing both input register and compare register in a single circuit.

5. A reverse search system for checking a string of subwords for the presence of one or more words out of a given list of words according to claim 1 wherein the said roller shifter means is a software.

6. A reverse search system for checking a string of subwords for the presence of one or more words out of a given list of words according to claim 1 wherein the said buffer sectioner means is an electronic circuit.

7. A reverse search system for checking a string of subwords for the presence of one or more words out of a given list of words according to claim 1 wherein the said reverse sarch system comprises a priority encoder that may be used to output the address of one of the matching words in the case that several words are found to be matching, in accordance with a predefined priority order.

8. A reverse search method for checking a string of subwords for the presence of one or more words out of a given list of words in a reverse search system comprising the following steps:
(a) storing a list of words within a memory array comprising a plurality of memory cells arranged according to a predefined order, such that each memory cell stores one sub word;
(b) dividing the said string of subwords into substrings having a number of subwords that is equal or smaller than a predefined number;
(c) storing one of the said substrings within an input buffer register circuit that is designed to contain a number of subwords equal or smaller than the said predefined number;
(d) repeatedly feeding the said substring into a compare register circuit with various roll shifted positions such that it may be checked in all required sub word positions;
(e) setting the delimiting lines to a first logic state, with the exception of the delimiting line that is associated with the memory cell of the said compare register storing the first subword of the said substring;
(f) putting in to the comparator means associated with each memory cell within the said memory array the data of one sub word stored in one cell of the said compare register respectively by means of bit lines associated to both of the said cells wherein the connections of the said bit lines are cyclically arranged such that the comparators of two adjacent memory cells k and k+1 receive as input the data of either two adjacent cells or of the last and first cell respectively, of the compare register;
(g) setting a word start signal and a word end signal for the memory cells that store the first and last subwords respectively of the word the presence of which in the said substring is to be checked;
(h) operating the said comparator means for executing simultaneous comparisons between the subwords stored in the memory cells within the said memory array and the subwords stored in the cells of the compare register that convey signals to the said subwords within the said memory array;
(i) setting a subword match signal at each matching memory cell of the said memory array in case that a match is found;
(j) logically combining the said subword match signals by means of logic circuits associated with each of the said memory cells: a) with the match signal of a preceding memory cell, b) with the said start and end word signals and c) with a partial match signal that is set where the preceding subwords of the word that is being checked are located in a preceding, adjacent substring and found to be matching;
(k) checking that all the memory cells preceding to the said memory cell are matching beginning with the starting subword of the said word by cumulatively combining the subword match signals of each of the said memory cells with the signals from the cells immediately preceding each of the said memory cells respectively;
(l) issuing a word match signal at the ending subword of the said word if all preceding subwords beginning with the starting subword of the said word were found matching;

9. A reverse search method for checking a string of subwords for the presence of one or more words out of a given list of words according to claim 8 hereinabove wherein in the case that more than one words are found matching a priority encoder is used to output the address of one of the matching words in accordance with a predefined priority order.

10. A reverse search method for checking a string of subwords for the presence of one or more words out of a given list of words according to claim 8 hereinabove wherein the said dividing of the said string of words into substrings is performed by a software means.

11. A reverse search method for checking a string of subwords for the presence of one or more words out of a given list of words according to claim 8 hereinabove wherein the said dividing of the said string of words into substrings is performed by a hardware means.

12. A reverse search method for checking a string of subwords for the presence of one or more words out of a given list of words according to claim 8 hereinabove wherein when one or more words of the said list are found to match, a List Match signal is set.

13. A reverse search method for checking a string of subwords for the presence of one or more words out of a given list of words according to claim 8 hereinabove wherein the number of shift roll operations required is equal to the number of subwords in the compare register.

14. A reverse search method for checking a string of subwords for the presence of one or more words out of a given list of words according to claim 8 hereinabove wherein each word of the said list is stored twice in the said memory array with the said two appearances of each of the said words respectively being positioned such that the first subword of the first appearance of a word is aligned with a subword of the compare register that is removed at a distance of n/2 subwords from the subword that is aligned with the first subword of the second appearance of the said word whereby the number of shift roll operations reqired is reduced to half the number of subwords in the compare register.

15. A reverse search method for checking a string of subwords for the presence of one or more words out of a given list of words according to claim 8 hereinabove wherein each word of the said list is stored X times in the said memory array with the said X appearances of each of the said words respectively being positioned such that the first subword of the first appearance of a word is aligned with a subword of the compare register that is removed at a distance of n/X subwords from the subword that is aligned with the first subword of the next appearance of the said word whereby the number of shift roll operations required is reduced to n/X the number of subwords in the compare register.

16. A logic combination method to be applied in a reverse search method for checking a string of subwords for the presence of one or more stored words out of a given list of words that is stored in a memory array with one subword being stored in each memory cell of the said memory array and a logic circuit being associated with each of the said memory cells wherein the logic circuit Li of a memory cell i outputs an intermediate combined signal Cbi which is input to the circuit of the next memory cell i+1 if one of the following conditions is verified:
(a) The intermediate combined signal Cbi-1 of the preceding circuit Li-1 is also set and the sub word Swᵢ within the said memory cell i is found matching and no signal is received from a delimiting line, indicating that the said sub word Swᵢ is not a first subword of a new sub string and that the present sub string has been found matching for all preceding sub words, starting from the first sub word of the stored word presently being checked—Or
(b) The said delimiting line is set, indicating that the said subword Swᵢ is a first subword of a new substring and a partial match signal is set indicating that a preceding operation on a previous adjacent sub string has resulted in the ending part of the said preceding string matching a part of the said stored word in the said memory array and the said subword Swᵢ is found matching—Or
(c) If a signal is set on the said delimiting line, indicating that the said subword Swᵢ is the first sub word of the sub string, and the said sub word Swᵢ is found matching;
And a word match is output if the CBᵢ signal is set, meaning that all preceding subwords of the said stored word have been found matching, and the said sub word Swᵢ is marked as the last sub word of the said stored word by a word end signal at the said sub word Swᵢ or by a word start signal at the next sub word Swᵢ₊₁;
And a partial match is output if the CBᵢ signal is set and the sub word is not the ending subword of the said stored word and the subword is aligned with the ending subword of the sub string.
